(19) United States
(12) Patent Application Publication
(10) Pub. No.: US 2014/0156624 A1
(43) Pub. Date: Jun. 5, 2014

(54) Producing, Archiving and Searching Social Content

(71) Applicant: MICROSOFT CORPORATION, Redmond, WA (US)

(72) Inventors: Omar Alonso, Redwood Shores, CA (US); Kartikay Khandelwal, Los Altos, CA (US)

(73) Assignee: MICROSOFT CORPORATION, Redmond, WA (US)

(21) Appl. No.: 13/693,528

(22) Filed: Dec. 4, 2012

(51) Int. Cl. G06F 17/30

(52) U.S. Cl. CPC G06F 17/30864
USPC 707/708

(57) ABSTRACT

A search engine configured to process social communications such that the social communications can be searched according to a specific time period is presented. The search engine (or related process) accesses a store or feed of social communications and segments the social communications according to time periods. The segments are processed such that a representative set of social communications related to topics of the time period are determined. The representative set of social communications is stored in a content store such that the search engine can retrieve them in response to a search query regarding social communications relating to a topic/time period.

### BACKGROUND

With more than 500 million registered users of Twitter® generating 175 million tweets every day, Twitter has become one of the largest sources of public opinion and information generation on the Internet. People “tweet” about a wide range of topics varying from personal feelings to opinions of ongoing events or topics of interest. However, in the way that Twitter manages, stores, and makes available the many tweets it is impossible to find any one tweet (or set of tweets) about an event that occurred in the past.

Modern online search engines provide a computer user with the ability to locate articles, blogs, Wikipedia pages, and the like all related to some prior event. However, while search engines have proven to be extremely useful, there remains a disconnect: search engines simply fail to offer the ability to locate the most popular tweets generated on any given day relating to a specific event. Indeed, unlike other content that is indexed and made available to computer users through search queries, search engines are unable to respond to search queries regarding the many social fragments from the past.

### SUMMARY

The following Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

According to aspects of the disclosed subject matter, a search engine configured to process social communications such that the social communications can be searched according to a specific time period is presented. The search engine (or related process) accesses a store or feed of social communications and segments the social communications according to time periods. The segments are processed such that a representative set of social communications related to topics of interest of the time period are determined. The representative set of social communications is stored in a content store such that the search engine can retrieve them in response to a search query regarding social communications relating to a topic of interest for a given time period.

According to further aspects of the disclosed subject matter, a computer-implemented method for facilitating access to social communications is presented. A plurality of social communications is access and the social communications are segmented according to predetermined time periods. The social communications of the segments are associated with a plurality of topics of interest concurrent with the predetermined time periods. A representative set of social communications is determined for the plurality of topics of interest and stored in a content store such that a computer user can submit a search query regarding social communications for a particular event and time period, and receive search results including social communications from the content store that correspond to the topic of interest and time period.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 is a pictorial diagram illustrating an exemplary networked environment suitable for implementing aspects of the disclosed subject matter;

FIG. 2 is a pictorial diagram of aspects of a networked environment for illustrating the flow of a social communication such that the information is made available to computer users by a search engine;

FIG. 3 is a flow diagram illustrating an exemplary routine for processing social communications in order to make the social communications available to computer user via a search engine;

FIG. 4 is a flow diagram illustrating an exemplary routine for reducing one or more segments of social communications to high quality social communications;

FIG. 5 is a flow diagram illustrating an exemplary routine for responding to a search query from a computer user regarding social communications surrounding a topic of interest of a given time period;

FIG. 6 is a pictorial diagram illustrating an exemplary user interface 600 for providing search services with regard to social communications; and

FIG. 7 is a block diagram illustrating exemplary components of a search engine suitably configured to respond to a search query from a computer user regarding social communications surrounding a topic of interest for a given time period.

### DETAILED DESCRIPTION

For purposed of clarity, the use of the term “exemplary” in this document should be interpreted as serving as an illustration or example of something, and it should not be interpreted as an ideal and/or leading illustration of that thing. A “social communication” refers to a communication from a person or entity intended for the viewing/consumption of others. The social communication may be directed to a specific person or persons, directed to a group of subscribers, or simply made available for viewing by one or more persons. For example, a person's “tweet” (or “retweet”) on the Twitter system may be viewed as a social communication. Similarly, person's “post” on the Facebook system may also be viewed as a social communication. Other social networking sites will have analogous social communications which can be advantageously archived, indexed and made searchable by a search engine according to aspects of the disclosed subject matter. The term “topic of interest,” as used throughout this document should be interpreted as the topic of one or more social communications. A topic of interest may be (by way of illustration and not limitation) an event, an organization, a person, a group of people, an object, a concept, and the like. Additionally, for readability purposes, the term “topic” should be viewed as synonymous with “topic of interest” (as well as corresponding plural forms) and “topic” will be primarily used through this document.

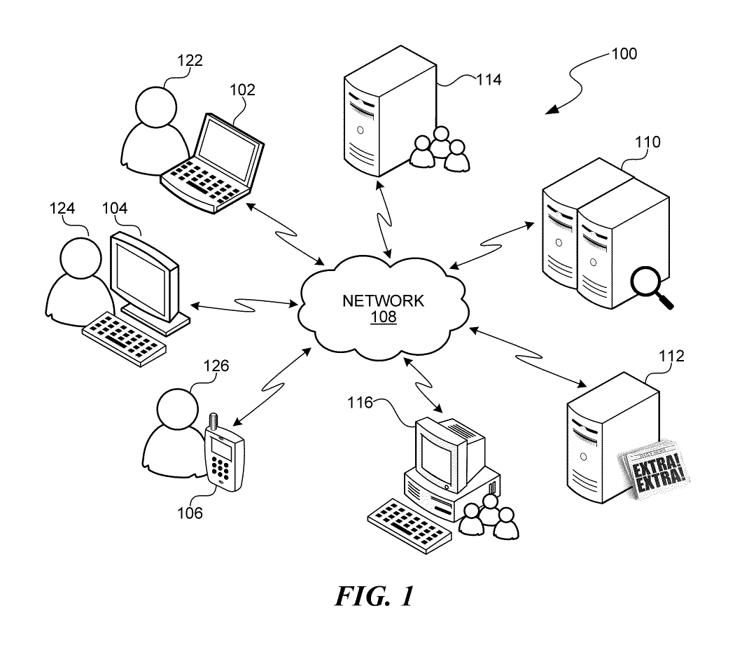

Turning to FIG. 1, this figure shows a pictorial diagram illustrating an exemplary networked environment 100 suitable for implementing aspects of the disclosed subject matter. The illustrative environment 100 includes one or more user computers, such as user computers 102-106, connected to a network 108, such as (by way of illustration and not limitation) the Internet, a wide area network or WAN, and the like. Also connected to the network 108 is a search engine 110 configured to facilitate access to social communications by way of obtaining and processing social communications including social communications from its own services, and responding to search queries for information (including social communications). More specific details regarding processing social communications such that they can be searched, as well as responding to search queries from users will be described in greater detail below.

Those skilled in the art will appreciate that, generally speaking, a search engine 110 corresponds to an online service hosted on one or more computers, or computing systems, located and/or distributed throughout the network 108. The search engine 110 receives and responds to search queries submitted over the network 108 from various computer users, such as the computer users 122-126 that are illustrated as being connected to user computers 102-106. In particular, responsive to receiving a search query from a computer user, the search engine 110 obtains search results information related and/or relevant to the received search query (as defined by the terms of search query.) The search results information includes search results, i.e., references (typically in the form of hyperlinks) to relevant and/or related content available from various network locations, including content-hosting sites such as sites 112-116, all located throughout the network 108. These content-hosting sites 112-116 may include various social networking sites that maintain data stores of social communications, such as social networking sites 114 and 116.

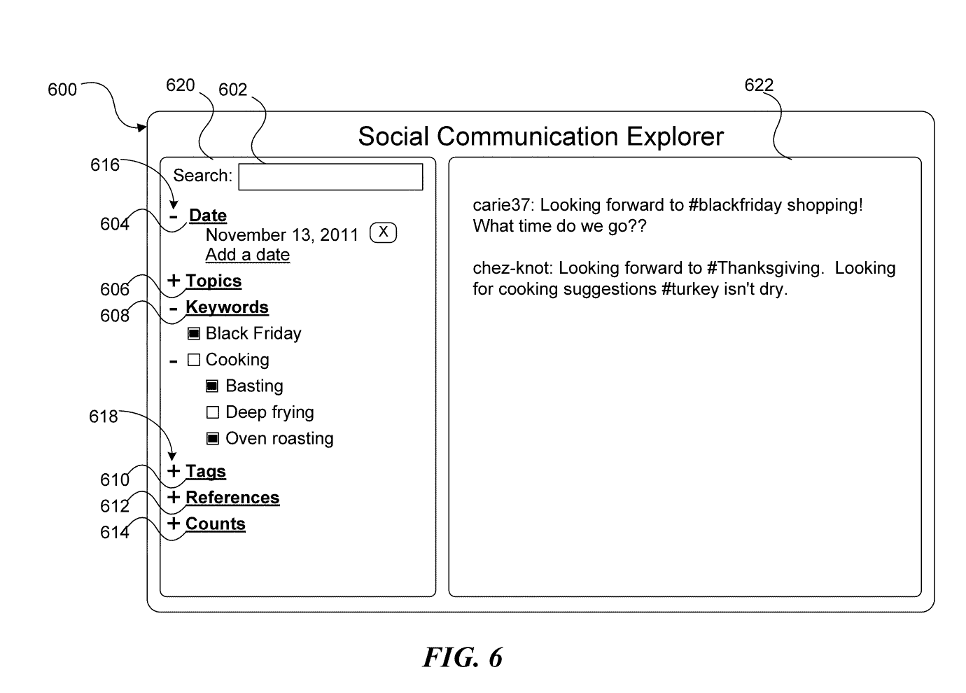

As those skilled in the art will appreciate, content-hosting sites 112-116 host or store content that is available and/or accessible to computer users (via user computers) over the network 108. Through the use of one or more processes that crawl the network scanning for content, the search engine 110 is made aware of at least some of the content hosted on the many content-hosting sites, such as content-hosting sites 112-116, located throughout the network 108. In addition to crawling the network, a search engine, such as search engine 110, may maintain a relationship with one or more content-hosting sites, such as social networking site 114, such that the content available on the site, which may include social communications, is made available directly to the search engine (hence, there is no need to crawl to that site.) A typical relationship between a search engine 110 and a social networking site 114 will be described in greater detail below. In any event, once content is located, at a general level the search engine 110 will process and store information regarding the hosted content in a content store (e.g., content store 616 of FIG. 6). Those skilled in the art will appreciate that a search engine will typically index the content according to one or more keywords, dates, or other significant aspects for more efficient retrieval in the content store. The search engine 110 draws from the content store when obtaining search results information in response to a search query from a computer user.

The search results information obtained by the search engine 110 in response to a search query may include (by illustration and not limitation) one or more social communications corresponding to a topic, particularly when the topic is the target subject matter of the query. Also, the search results information will typically include one or more search results: hyperlinks to related or relevant content available to the computer user on the network 108. The search results information may further include related and/or recommended alternative search queries, data and facts regarding the target subject matter of the search query, images pertaining to the subject matter of the search query, products and/or services related or relevant to the search query, advertisements, and the like.

As those skilled in the art will appreciate, quite frequently the search services offered by a search engine 110 will appear as a free service, i.e., a computer user is not charged a pecuniary amount for the search results provided in response to a search query (also synonymously referred to as a search request). Instead, the search results information (generated in one or more a search results pages) includes and/or is combined with advertisements such that the search service is “ad supported,” i.e., financed by advertisements paid for by advertisers.

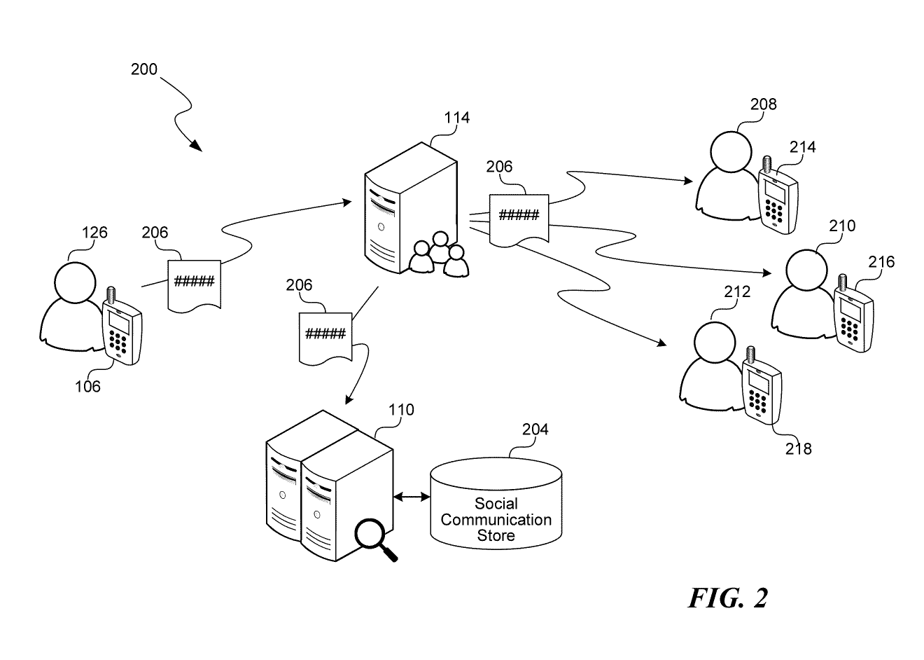

While the networked environment 100 of FIG. 1 describes a suitable network environment in which a search engine 110 can facilitate access to social communications related to topics of interest, a more detailed description of how the search engine provides this information is in order. FIG. 2 is a pictorial diagram of aspects of a networked environment 200 for illustrating the flow of social communications such the communications are made available to computer users by a search engine 110. For purposes of illustration, a single computer user 126 in communication over a network (not shown) with the social networking site 114 is described. However, as those skilled in the art will appreciate, in typical situations there will be many computer users transmitting any number of social communications to one or more social networking sites.

As shown in the networked environment 200, the social networking site 114 receives a social communication 206 from computer user 126 (via computer 106). The social networking site 114 will typically store the social communication 206 in its own content store (not shown) as well as make the social communication available to one or more computer users 208-212 connected over the network via computing devices 214-218. By way of example, a concert-going computer user may issue a tweet regarding the concert. The tween is received by the Twitter service who broadcasts the tweet to the computer user's subscribers. Or, as a non-limiting, alternative example, a Facebook user may post information on his/her wall and, for those friends closely following the user, the post will be displayed to posting user's friends.

Irrespective of the particular social networking service in use, a search engine 110 also gains access to the computer user's social communication 206. According to various aspects of the disclosed subject matter, this access may occur synchronously with the distribution of the social communication 206 to the computer user's friends/subscribers 208-212, or may occur asynchronously with the distribution of the social communication. Similarly, the social communication 206 may be accessed singly or as a block with many other social communications. Further still, the social network site 114 may initiate access to the social communication 206 or, alternatively, the search engine 110 may initiate access to this and other social communications. In sum, irrespective of the particular details regarding when and how the social communication 106 is made available to the search engine 110 from the social network site 114, at some point the search engine has access to the social communication.

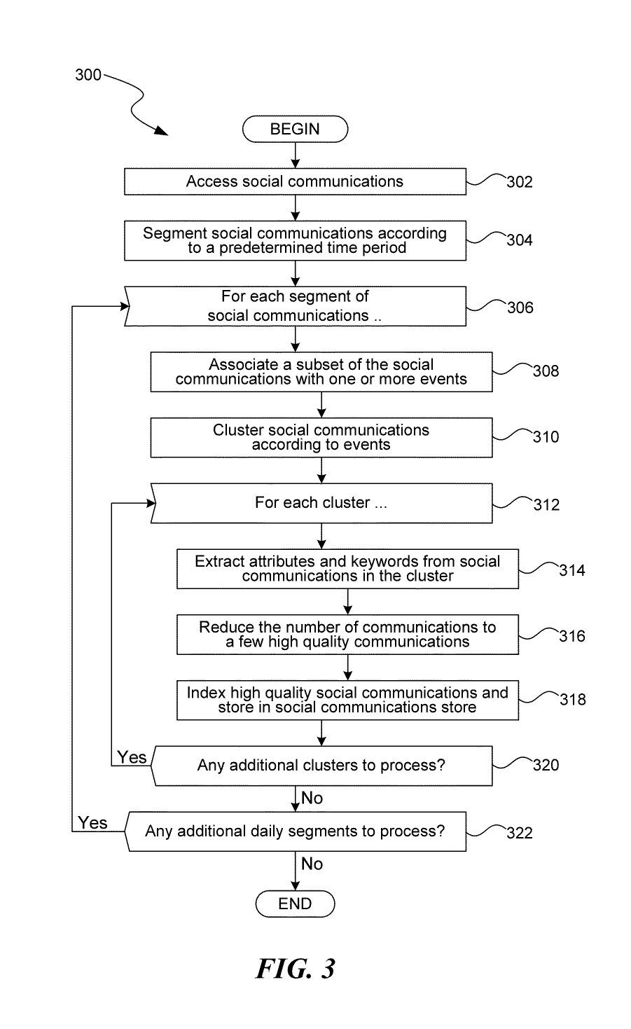

At a general level, a social communication processing component of the search engine 110 takes the social communication 206, processes it and stores information regarding the social communication in a social communication store 204 associated with the search engine. According to one embodiment of the disclosed subject matter, the social communication 206 is stored in the social communication store 204, while in an alternative embodiment references to the social communication are stored in the social communication store 204. Of course, as indicated above, while this discussion is made in the context of a single social communication 206 from one computer user 126, in most embodiments there will be many computer users associated with multiple social networking sites creating numerous social communications for distribution to others. In this larger context, the search engine 110 gains access to the social communications (e.g., in a block or as a stream) from the various social networking sites, processes all of the social communications according to (at a minimum) a topic of interest and a date, stores the resulting information in a social communication store 204 that is made available to computer users via search queries. Processing social communications such that they are available to computer users is described hereafter in conjunction with FIG. 3.

FIG. 3 is a flow diagram illustrating an exemplary routine 300 for processing social communications in order to make the social communications available to computer user via a search engine 110. In particular, at block 302, the search engine 110 accesses the social communications. As already mentioned, accessing socialist communications may comprise ingesting feeds or streams from social communication networking sites, receiving a set of social communications from one or more social networking sites, or gaining access to social communications stored by social networking sites. With access to the social communications, at block 304, the search engine 110 segments the social communications according to a predetermined time period. For example, the search engine 110 may segment the social communications according to the date in which the social communication were created. Of course, while segmenting social communications according to their date of creation (based on a Gregorian calendar date) is one embodiment, in an alternative or conjunctive embodiment, the social communications may be segmented into other time periods (according to the creation of the social communications) such as by week, by month, by year, by hour of the day, and the like. Accordingly, while the remainder of the following discussion will be made primarily with regard to segmenting the social communications according to their creation date, this should be viewed as illustrative and not limiting upon the disclosed subject matter.

At block 306 a looping construct is begun to iterate through each of the segments of social communications. Thus, at block 308, in processing the currently selected segment of social communications, at least a subset of the social communications (of this segment) is associated with one or more identifiable topics of interest that correspond to the time period of this segment. At block 310, the social communications associated with the one or more topics are clustered according to topics. According to aspects of the disclosed subject matter, the one or more topics of interest may be predetermined topics provided to the process and associated with the particular time period for this segment. Also, one or more topics of interest may be determined/derived from the content of the social communications of the currently processed segment. Still further, the topics of interest with which the social communications are associated may be a combination of both predetermined and derived topics. According to one embodiment, when the number of social communications related to a particular topic is below a threshold amount, that topic is eliminated in regard to processing of the social communications.

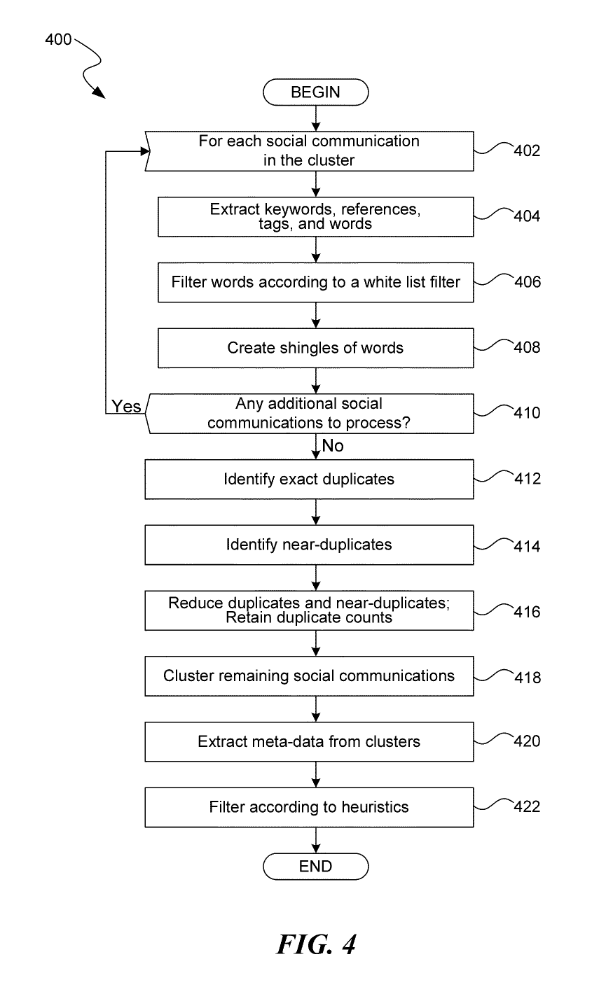

At control block 312, another looping construct is begun to iterate through each of the clusters (each cluster associated with a topic of interest and all of the clusters being part of a segment of social communications for a particular time period.) Hence, at block 314, attributes and keywords are extracted from the social communications in the currently processed cluster. These extracted attributes and keywords may be used as indexing terms or keywords when stored in the social communication store 204. At block 316, the number of social communications from the currently processed cluster is reduced to subset of “high quality” social communications. These “high quality” social communications are viewed as robust and representative of the social communications in the cluster. According to various embodiments of the disclosed subject matter, “high quality” social communications may be constructed from one or more search actual social communications in the cluster and/or selected from the social communications in the cluster. Reducing the cluster of social communications to high quality social communications is described in greater detail below in regard to routine 400 of FIG. 4. At block 318, the high-quality, representative set of social communications for the cluster are indexed and stored in the social communication store 204. As mentioned above, indexing may be based on several factors, including but not limited to: the keywords and attributes of the social communications of the cluster; the time period (or time periods) corresponding to the cluster of social communications; the topic of interest associated with the cluster; and the like.

At block 320, the determination is made as to whether there are other clusters for the currently selected segment to be processed. If there are other clusters to be processed, the routine returns back to block 312 where the next cluster to be processed is selected and steps 314-318 are repeated for the newly selected cluster. Alternatively, if there are no additional clusters to process for this segment, the routine 300 proceeds to block 322. At block 322, the determination is made as to whether there are any additional segments of social communications to be processed. If there are additional segments of social communications to process, the routine 300 returns to block 306 in repeats steps 308-318 as described above. Alternatively, if there are no additional segments of social communications to be processed, the routine 300 terminates.

Often each cluster of social communications will comprise a substantial number of social communications. Moreover, in many cases, a sizeable percentage of the social communications will be duplicates or near-duplicates. For example, assume that a first computer user issues a communication about a popular topic which is transmitted to over a hundred subscribers. These subscribers, recognizing the importance of the original communication, quickly re-transmit the communication to their subscribers, and so on. The retransmitted communication may be slightly different (e.g., having an indication that it is a retransmission of an earlier communication) but, generally speaking, the retransmitted communication is a near-duplicate of the original. As can be seen, for a mildly popular topic the body of social communications can grow quickly and exponentially. A computer user issuing a search query regarding the topic will not want to see all of the duplicate and near-duplicate versions of the original communication. Moreover, the computer user will want to see only interesting social communications regarding the topic. Accordingly, it is often desirable to reduce a cluster of social communications to high quality social communications including (by way of illustration and not limitation) those social communications that are most meaningful, most informative, and/or most representative of the cluster. To this end, FIG. 4 is a flow diagram illustrating an exemplary routine 400 for reducing one or more clusters of social communications to high quality social communications.

Beginning at block 402, a looping construct is begun to iterate through each of the social communications in the cluster being processed. Thus, at block 404, important content in the social communication is extracted including, by way of illustration and not limitation, keywords, references (or referenced information), tagged content, the words of the communication, terms, and the like. At block 406, the words of the communication are filtered according to a “white list” filter, thereby removing those words that may be offensive, objectionable, and the like. At block 408, “shingles” are created from the remaining words of the social communication. As will be discussed below, shingles are used to identify duplicate and near-duplicate social communications in the current cluster. Shingles are representative characters of the words in the document. In one embodiment, a 5-character shingle is used. The 5-character shingles for the phrase “Superstorm Sandy strikes north-east coast” includes: “super”; “storm”; “sand”; “y str”; “ikes”; “north”; “-east”; “coas”; and “t”. The shingles are temporarily maintained with the social communication in the current routine 400 for further processing.

At block 410, the determination is made as to whether there are any additional social communications in the current cluster to process. If so, the routine 400 returns to block 402 to process the additional social communications. Otherwise, the routine 400 proceeds to block 412. At block 412, exact duplicates are identified. In one embodiment, exact duplicates are identified by performing a hash the shingles of the social communications and locating all of the duplicates according to the hash values. Similarly, at block 414, a partial hash of the shingles is performed and near-duplicate social communications are identified. Thus, at block 416, the routine 400 reduces the number of social communications in the cluster by removing all by one of the duplicates and near-duplicates—though the count of the social communications that are removed is retained and associated with the retained social communications (in order to determine popularity of the social communications.)

After removing duplicates and near-duplicates, at block 418 the remaining social communications are clustered. At block 420, meta-data and subtopics are extracted from the recently made clusters—in addition to the important context already extracted. This information is indexed with the social communications of the segment in the content store and can be used as filters and/or pivots for viewing content. At block 422, the remaining social communications are filtered according to various heuristics to identify a small set of representative, high quality social communications for the cluster. These heuristics may include (by way of illustration and not limitation) the popularity (i.e., frequency of retransmission) of the social communication, a predetermined list of important keywords and topics; the robustness of the social communication, and the like. While not shown, in addition to identifying the high quality social communications, the social communications remaining in the cluster may be scored and sorted according to similar heuristics such that when a computer user searches for topics of interest with regard to a prior time period, the highest quality/scoring social communications may be presented, thereby eliminating a lot of “noise.” Thereafter, the routine 400 terminates.

The descriptions of routines 300, 400, and 500 have been made in regard to segmenting social communications with regard to a specific time period (e.g., a calendar date, a calendar month, an hour, etc.) However, in addition to segmenting and storing the social communications according to a time period, the various segments may be aggregated in various forms. For example, assuming that the time period for segmenting social communications and processing them (as described above) is a calendar date, the various days of a month may be aggregated to create a monthly view of social communications. Continuing this this example, while a computer user may be able to retrieve and obtain information regarding social communications of a particular topic of interest for a particular calendar date, by aggregating the information the computer user may also be able to view how a particular topic trends over the aggregated month.

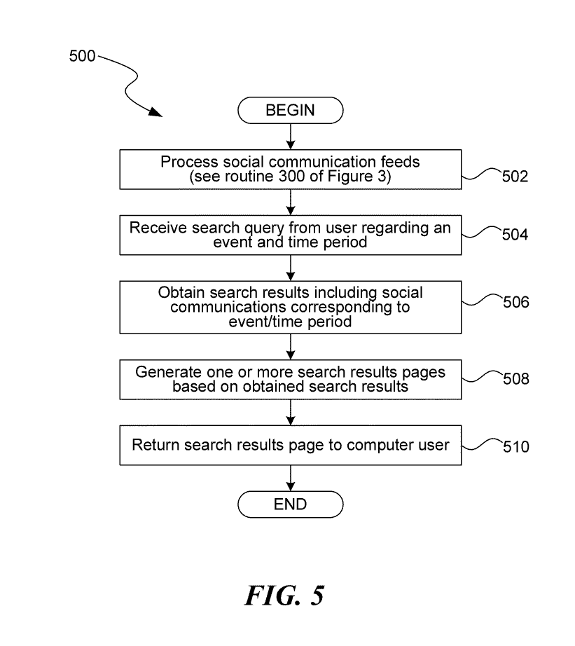

With the social communications segmented and stored in the social communication store 204, the search engine 110 is able to respond to search queries from computer users regarding social communications relating to topics of interest of a particular day (or time period). FIG. 5 is a flow diagram illustrating an exemplary routine 500 for responding to a search query from a computer user regarding social communication surrounding a topic relating to a prior time period. Beginning at block 502, social communication feeds and or other sources are processed (as described above in regard to FIG. 3.) At block 504, the search engine 110 receives a search query from a computer user regarding a topic relating to a prior time period. The search query, in at least one embodiment, includes the particular time period for which the computer user is requesting social communications.

At block 506, the search engine 110 obtains search results including social communications that are stored in the social communication store 204 corresponding to the requested topic of interest and time period. At block 508, the search engine 110 generates one or more search results pages based on the obtained search results. At block 510, the search engine 110 returns at least one of the generated search pages to the computer user in response to the search query.

Regarding routines 300, 400 and 500 of FIGS. 3-5 respectively, it should be appreciated that while the routines are expressed with discrete steps in processing social communications such that they may be made available via a search engine 110, these steps should be viewed as being logical in nature and may or may not correspond to any actual and/or discrete steps. Nor should the order that these steps are presented in the various, illustrative routines be construed as the only order in which the steps may be carried out. While these steps include various novel features of the disclosed subject matter, other steps (not listed) may also be carried out in the execution of the various routines. Further, those skilled in the art will appreciate that logical steps may be combined together or be comprised of multiple steps. Steps of routines 300, 400 and/or 500 may be carried out in parallel or in series. Often, but not exclusively, the functionality of the various routines is embodied in software (e.g., applications, system services, libraries, and the like) that is executed on computer hardware such as the user computers 102-106 described above or the system described below in regard to FIG. 6.

While the above-described novel aspects of the disclosed subject matter are expressed in routines, applications (also referred to as computer programs), and/or methods, these aspects may also be embodied in instructions stored in computer-readable media (also referred to as computer-readable storage media). As those skilled in the art will appreciate, computer-readable media can host computer-executable instructions for later retrieval and execution. When executed on a computing device, the computer-executable instructions stored on one or more computer-readable storage devices carry out various steps, methods and/or functionality, including those steps, methods, and routines described above. Examples of computer-readable media include, but are not limited to: optical storage media such as Blu-ray discs, digital video discs (DVDs), compact discs (CDs), optical disc cartridges, and the like; magnetic storage media including hard disk drives, floppy disks, magnetic tape, and the like; memory storage devices such as random access memory (RAM), read-only memory (ROM), memory cards, thumb drives, and the like; cloud storage (i.e., an online storage service); and the like. For purposes of this disclosure, however, computer-readable media expressly excludes carrier waves and propagated signals.

In addition to, or as an alternative to, displaying a search result page that includes items other than social communications, a search engine 110 or other service that processes and makes social communications available (as described above) may provide a user interface configured to permit a computer user to specially view social communications for a particular date or other time period, aggregate the social communications of multiple time periods, sort and/or filter the social communications according to keywords, tags, references, topics, sub-topics, and the like. Indeed, FIG. 6 is a pictorial diagram illustrating an exemplary user interface 600 for providing search services with regard to social communications.

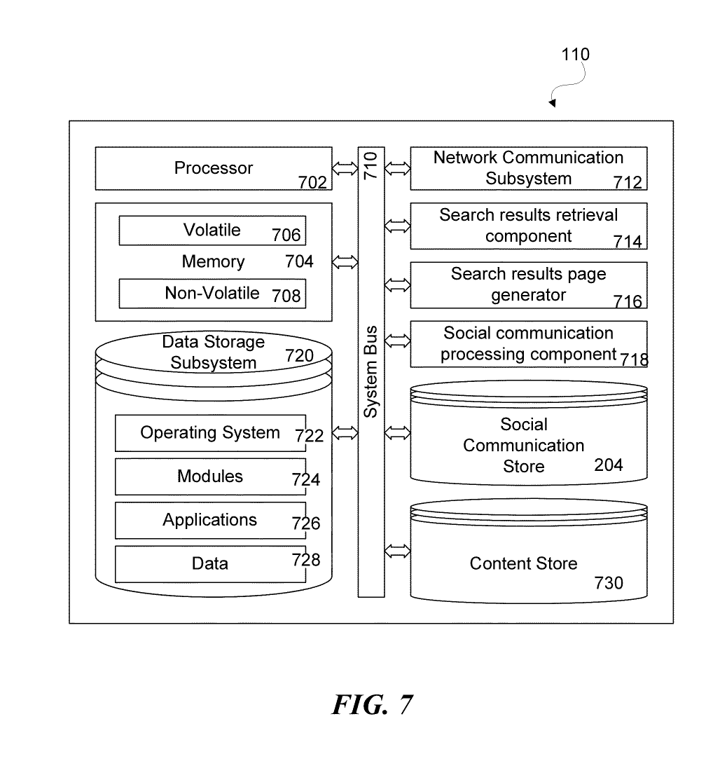

As shown in FIG. 6, the user interface 600 includes a filter area 620 as well as a results area 622. Through the use of controls in the filter area 620 a computer user can input various criteria to specify the factors upon which a search of social communications should be made. As shown (by way of illustration and not limitation), the filter area 620 includes a search field 602 into which the computer user can enter various terms that are to found in (or related to) social communications. Also included in the filter area 620 are various key factors 604-614 that correspond to index keys in a social communication store 204 (see FIG. 7). Various field values for these index keys may be accessed using the expand (e.g., control 616) and collapse (e.g., control 618) controls, or other suitable user interface mechanisms. As shown, a computer user may enter and/or remove one or more time periods as well as search for keywords (via control 608), tagged content (via control 610), referenced subjects, specify counts (i.e., the number of social communications associated with specific queries), and the like.

Referring now to FIG. 7, FIG. 7 is a block diagram illustrating exemplary components of a search engine 110 suitably configured to respond to a search query from a computer user regarding social communications surrounding a topic of interest or concurrent with a prior time period. Indeed, FIG. 7 and the following description are intended to provide a brief, general description of a suitably configured search engine 110 as a computer system in which the various aspects of the disclosed subject matter can be implemented.

The search engine 110 includes a processor (or processing unit) 702 and a memory 704 interconnected by way of a system bus 710. As those skilled in the art will appreciate, the processor 702 executes instructions retrieved from the memory 704 in carrying out various functions, particularly in processing social communications for access by computer users and responding to search queries for the same. The processor 702 may be comprised of any of various commercially available processors such as single-processor, multi-processor, single-core units, and multi-core units. Moreover, those skilled in the art will appreciate that the novel aspects of the disclosed subject matter may be practiced with other computer system configurations, including but not limited to: mini-computers; mainframe computers, personal computers (e.g., desktop computers, laptop computers, tablet computers, etc.); handheld computing devices such as smartphones, personal digital assistants, and the like; microprocessor-based or programmable consumer electronics; and the like.

The memory 704 may be comprised of both volatile memory 706 (e.g., random access memory or RAM) and non-volatile memory 708 (e.g., ROM, EPROM, EEPROM, etc.) Moreover, the memory 704 may obtain data and/or executable instructions (especially within the volatile memory 706) from the data storage subsystem 720 by way of the system bus 710. Moreover, a basic input/output system (BIOS) can be stored in the non-volatile memory 708 and include the basic routines that facilitate the communication of data and signals between components within the computing system 700, such as during startup of the computing system. The volatile memory 706 may also include a high-speed RAM such as static RAM for caching data.

The system bus 710 provides an interface for search engine's components to inter-communicate. The system bus 710 can be of any of several types of bus structures that can interconnect the various components (including both internal and external components). The illustrative search engine 110 further includes a network communication subsystem 712 for interconnecting the search engine with other computers (such as user computers 102-106 and social networking sites 114-116) and devices on a computer network 108. The network communication subsystem 712 may be configured to communicate with an external network, such as network 108, via a wired connection, a wireless connection, or both.

The data storage subsystem 720 provides a storage system in addition to the memory 704. Typically, within the data storage subsystem 718 can be found the operating system 722 (for retrieval into memory for execution) of the search engine 110, applications 726 (which may include one or more applications to assist the search engine in responding to search queries from computer users as well as accessing social communications from social networking sites); executable modules 724; as well as data 728 that the search engine may need to operate.

Further included in the illustrated search engine 110 is a search results retrieval component 714 that is responsible obtaining search results in response to a search query received from a computer user. The search results retrieval component 714 implements the functionality of responding to a search query directed to social communications of topics of interest for a prior time period, as described above in regard to routine 500 of FIG. 5. Search results content is retrieved from the content store 720 as well as the social communication store 204. The search engine 110 also includes a search results page generator that generates one or more search results pages from the results/content obtained by the search results retrieval component 714, which may include social communications regarding a prior even, for a computer user in response to a search query.

Further included in the illustrated search engine 110 is a social communication processing component 718. The social communication processing component 718 implements the functionality of processing social communications accessed from social networking sites (via the network communication subsystem 712) and storing the processed information in the social communication store 204, thus making the information available to a computer user for searching purposes. While the content store 730 and the social communication store 204 are identified in FIG. 7 as being separate entities, this is a logical separation for illustration purposes and should not be viewed as being a limitation on the disclosed subject matter. In various embodiments, the social communication store 204 and the content store 730 are the same storage.

It should be appreciated, of course, that many of the components and/or subsystems described as being part of the search engine 110 should be viewed as logical components for carrying out various functions of a suitably configured search engine—particularly one that makes social communications of topics of interest concurrent with a prior time period available to a computer user. As those skilled in the art appreciate, logical components (or subsystems) may or may not correspond directly in a one-to-one manner to actual components, including the components described above in regard to the search engine 110 of FIG. 7. Moreover, in an actual embodiment, these components may be combined together or broke up across multiple actual components and/or implemented as cooperative processes on a network 108.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A computer-implemented method for facilitating access to social communications, the method comprising:
accessing a plurality of social communications;
segmenting the social communications according to predetermined time periods;
for each segment of social communications:
associating the social communications of the segment with a plurality of topics concurrent with the predetermined time period of the segment; and
determining a representative set of social communications for each of the plurality of topics from the social communications associated with each topic; and
indexing and storing the representative set of communications for each of the plurality of topics in a content store according to the predetermined time period and the associated topic.

2. The computer-implemented method of claim 1 further comprising clustering the social communications to corresponding topics; and
wherein determining a representative set of social communications for each of the plurality of topics from the social communications associated with each topic comprises determining a representative set of social communications from the cluster of social communications associated with a topic.

3. The computer-implemented method of claim 1 further comprising extracting keywords and attributes from the social communications; and
wherein determining a representative set of social communications for each of the plurality of topics from the social communications associated with each topic comprises determining a representative set of social communications according to the extracted keywords and attributes.

4. The computer-implemented method of claim 1, wherein the corresponding topics comprise a set of predetermined topics associated with the time period of the segment.

5. The computer-implemented method of claim 1, wherein the corresponding topics comprise a set of topics derived from the social communications associated with the time period of the segment.

6. The computer-implemented method of claim 5, wherein the corresponding topics further comprise a set of predetermined topics associated with the time period of the segment.

7. The computer-implemented method of claim 1, wherein determining a representative set of social communications for each of the plurality of topics comprises determining a representative set of social communications for each of the plurality of topics having at least a threshold number of social communications associated with the topic.

8. The computer-implemented method of claim 1, wherein the predetermined time period corresponds comprises a date.

9. The computer-implemented method of claim 1 further comprising:
receiving a search query from a computer user, the search query corresponding to social communications regarding an identified topic of the plurality of topics;
obtaining search results satisfying the search query from a content store, the search results including the representative set of social communications for the identified topic;
generating at least one search results page from the obtained search results including at least one social communication of the representative set of social communications; and
providing the at least one search results page to the computer user.

10. A computer-readable medium bearing computer-executable instructions which, when executed on a computing system comprising at least a processor executing instructions retrieved from the medium, carry out a method comprising:
accessing a plurality of social communications;
segmenting the social communications according to predetermined time periods;
for each segment of social communications:
associating the social communications of the segment with a plurality of topics concurrent with the predetermined time period of the segment; and
determining a representative set of social communications for each of the plurality of topics from the social communications associated with each topic; and
indexing and storing the representative set of communications for each of the plurality of topics in a content store according to the predetermined time period and the associated topic.

11. The computer-readable medium of claim 10, wherein the method further comprises extracting keywords and attributes from the social communications; and
wherein determining a representative set of social communications for each of the plurality of topics from the social communications associated with each topic comprises determining a representative set of social communications according to the extracted keywords and attributes.

12. The computer-readable medium of claim 10, wherein the corresponding topics comprise a set of predetermined topics associated with the time period of the segment.

13. The computer-readable medium of claim 10, wherein the corresponding topics comprise a set of topics derived from the social communications associated with the time period of the segment.

14. The computer-readable medium of claim 13, wherein the corresponding topics further comprise a set of predetermined topics associated with the time period of the segment.

15. The computer-readable medium of claim 10, wherein determining a representative set of social communications for each of the plurality of topics comprises determining a representative set of social communications for each of the plurality of topics having at least a threshold number of social communications associated with the topic.

16. The computer-readable medium of claim 10, wherein the method further comprises:
receiving a search query from a computer user, the search query corresponding to social communications regarding an identified topic of the plurality of topics
obtaining search results satisfying the search query from a content store, the search results including the representative set of social communications for the identified topic;
generating at least one search results page from the obtained search results including at least one social communication of the representative set of social communications; and
providing the at least one search results page to the computer user.

17. A computer-implemented search engine for responding to a search queries, the system comprising a processor and a memory, wherein the processor executes instructions stored in the memory as part of or in conjunction with additional components, the additional components comprising:
a social communication processing component configured to:
segment a plurality of social communications according to predetermined time periods;
for each segment of social communications:
associate the social communications of the segment with a plurality of topics of interest concurrent with the predetermined time period of the segment; and
determine a representative set of social communications for each of the plurality of topics of interest from the social communications associated with each topic of interest; and
index and store the representative set of social communications for each of the plurality of topics of interest in a content store according to the predetermined time period and the associated topic of interest.

18. The computer-implemented search engine of claim 17, wherein the corresponding topics of interest comprise a set of topics of interest derived from the social communications associated with the time period of the segment.

19. The computer-implemented search engine of claim 18, wherein the corresponding topics of interest comprise a set of predetermined topics of interest associated with the time period of the segment.

20. The computer-implemented search engine of claim 17 further comprising:
a search results retrieval component configured to obtain a plurality of search results responsive to the search engine receiving a search query corresponding to social communications regarding an identified topic of interest of the plurality of topics of interest, the plurality of search results including a representative set of social communications for the identified topic of interest; and
a search results page generator configured to generate at least one search results page from the obtained search results including at least one social communication of the representative set of social communications, and provide the at least one search results page in response to receiving the search query.
